(19) United States
(12) Patent Application Publication
(10) Pub. No.: US 2025/0361725 A1
(43) Pub. Date: Nov. 27, 2025

(54) SELF-ADHERING ROOFING UNDERLAYMENT

(71) Applicant: Arista Construction Systems FZE, Dubai (AE)

(72) Inventors: Manish SETH, Burnaby (CA); Gregory K. JONES, Mechanicsville, VA (US)

(21) Appl. No.: 19/288,559

(22) Filed: Aug. 1, 2025

Related U.S. Application Data
(63) Continuation of application No. PCT/EP2024/052649, filed on Feb. 2, 2023.
(60) Provisional application No. 63/443,232, filed on Feb. 3, 2023.
(60) Provisional application No. 63/509,942, filed on Jun. 23, 2023.

(51) Int. Cl. E04D 5/14; E04D 5/10

(52) U.S. Cl. CPC E04D 5/148; E04D 5/10

(57) ABSTRACT

A self-adhering underlayment includes an activator layer on the surface side that is configured to activate and bond with the adhesive when configured in contact with the adhesive layer, such as when overlapped on a roof. The activator layer may be a strip configured proximal an edge of the self-adhering underlayment, such that a second self-adhering underlayment will overlay and contact this activator layer strip when installed on a roof. The activator layer may be configured to chemically react with the adhesive layer to enable adhesion between the layers. The activator layer may comprise a chemical that chemically bonds with the adhesive layer. The activator layer may not be a tacky adhesive and therefor a release liner for the activator layer may not be required.

### CROSS REFERENCE TO RELATED APPLICATIONS

This application is a continuation of International patent application No. PCT/EP2024/052649 having an international filing date of Feb. 2, 2024, which claims the benefit of priority to U.S. provisional application No. 63/443,232, filed on Feb. 3, 2023 and U.S. provisional application No. 63/509,942, filed Jun. 23, 2023; the entireties of all prior application are hereby incorporated by reference herein.

### BACKGROUND OF THE INVENTION

### Field of the Invention

The invention relates to a self-adhering roofing underlayment having an activator layer with an activator that is configured to bond with an adhesive layer of an overlapped self-adhering roofing underlayment.

### Background

Roofing underlayment is used to provide a layer of additional resistance for moisture to pass through the roof into the building and may be non-breathable synthetic material. The roofing underlayment is applied over the plywood and shingles are mechanically attached to the roof, such as by roofing nails through the shingle, through the roofing underlayment and into the plywood. Roof underlayment may be configured with a surface adhesive strip that is configured to bond with the adhesive layer of another roof underlayment when overlapped on a roof. The surface adhesive strip requires a surface release liner over this strip to prevent adhesion when in a roll form.

### SUMMARY OF THE INVENTION

The invention is directed to a self-adhering underlayment that includes an activator layer on the surface side that is configured to activate and bond with the adhesive when configured in contact on a roof. The activator layer may be a strip configured proximal an edge of the self-adhering underlayment, such that a second self-adhering underlayment will overlay and contact this activator layer strip when installed on a roof. The activator layer may be configured to chemically react with the adhesive layer to enable adhesion between the layers. The activator layer may comprise a chemical that chemically bonds with the adhesive layer. The activator layer may not be a tacky adhesive and therefore a release liner for the activator layer may not be required. An activator layer may be non-tacky as defined as not adhering when pressed against the barrier layer of the self-adhering underlayment comprises for one minute with a pressure 70 kPa.

An exemplary self-adhering underlayment comprises a barrier layer, and an adhesive layer for bonding to a roof. The barrier layer may include a structural component such as a woven or non-woven fabric or scrim and a water barrier component, such as a polymer coating or film layer attached to the structural component. In an exemplary embodiment, the structural component is a woven material and the water barrier component is a coating of polymer on the woven structural component.

A water barrier component may be selected based on the application and location of use. Very wet areas may require a more substantial or thicker water barrier component while more arid locations may require minimal water barrier thickness. A water barrier component may include a polymer coating or a polymer film that may be olefin, polypropylene, polyethylene, polyester, polyurethane and the like. The polymer films may be tensilized to increase the modulus. The polymer films may be uniaxially oriented, wherein they are tensilized in one direction, the machine direction, or they may be biaxially oriented, wherein they are tensilized in both the machine direction and cross-machine direction. The polymer films may have a thickness of about 10 mm or less, about 6 mm or less, about 4 mm or less, about 2 mm or less, or even about 1 mm or less.

A self-adhering underlayment may be a solid layer to prevent liquid water passage but may have a high moisture vapor transmission rate (MVTR) to enable moisture in the house to pass through the housewrap to prevent mold. An exemplary self-adhering underlayment may include a high MVTR layer including urethane, copolyester elastomer, microporous PP or PE, ethyl/ethylacrylate copolymer, ethyl/methylacrylate copolymer, and the like. This MVTR layer may be configured as the water barrier component. The moisture vapor transmission rate (MVTR) through the self-adhering underlayment according to ASTM E96-00 may be about 2.0 perm or more, about 3.0 perm or more, about 4.0 perm or more, and even at least 5.0 perm or more.

An adhesive layer may be coupled to the barrier layer on the roof side to enable direct attachment to the exterior roof surface of a building. An adhesive layer may extend substantially over the entire roof surface of the self-adhering roof underlayment, or over at least 90% of the surface area. An adhesive layer may be a pressure sensitive adhesive that is configured in a continuous layer or as a discontinuous layer, such as dots or a grid or adhesive. The adhesive release liner is configured over the adhesive layer to prevent adhesion of adjacent layers when in a roll form.

In an exemplary embodiment, a self-adhering roof underlayment has a dual bond between overlapped pieces of self-adhering roof underlayment in an overlap area. A first adhesive bond is formed by the activator layer of a first or bottom layer of self-adhering roof underlayment bonding to the adhesive layer of a second layered self-adhering roof underlayment. A second adhesive bond is formed between an adhesive extension activator layer on an adhesive extension of a first of bottom layer of self-adhering roof underlayment and the adhesive layer of a second layered self-adhering roof underlayment. This dual bond prevents dammed water and wind-driven water from penetrating through the overlapped area of the two pieces of self-adhering roof underlayment.

### Definitions

Moisture vapor transmission rate through the barrier composite may be measured using ASTM E96-00 (Last Updated: Aug. 16, 2017), Water Vapor Transmission. ASTM E96 tests and evaluates the water vapor transfer through semi-permeable and permeable samples.

The summary of the invention is provided as a general introduction to some of the embodiments of the invention and is not intended to be limiting. Additional example embodiments including variations and alternative configurations of the invention are provided herein.

### BRIEF DESCRIPTION OF SEVERAL VIEWS OF THE DRAWINGS

The accompanying drawings are included to provide a further understanding of the invention and are incorporated in and constitute a part of this specification, illustrate embodiments of the invention, and together with the description serve to explain the principles of the invention.

FIG. 1 shows a cross sectional view of layers of roof underlayment of the prior art including a release liner over the adhesive layer and a second surface adhesive liner over a surface adhesive strip configured to bond to the adhesive layer when configured on a roof.

FIG. 2 shows a perspective view of the prior art roof underlayment with both release liners removed and being attached to a roof with the surface adhesive strip bonding to the adhesive layer on the roof side of the roof underlayment.

FIG. 3 shows a cross sectional view of layers of an exemplary self-adhering roof underlayment that includes an activator layer on a surface side configured to activate the adhesive on the adhesive layer on the roof side of the self-adhering roof underlayment.

FIG. 4 shows a cross sectional side view of two pieces of exemplary self-adhering roof underlayment being attached together on a roof with the activator layer configured to contact the adhesive.

FIG. 5 shows a perspective view of the self-adhering underlayment with both the adhesive release liners removed from the adhesive layer and the adhesive layer of a first self-adhering underlayment being attached to the activator layer of the second self-adhering underlayment.

FIG. 6 shows a cross sectional view of layers of an exemplary self-adhering roof underlayment that includes an activator layer on a surface side configured to activate the adhesive on the adhesive layer on the roof side of the self-adhering roof underlayment and an adhesive extension activator layer on an adhesive extension that extends from the barrier layer to bond to the adhesive layer of an overlapping self-adhering roof underlayment.

FIG. 7 shows a cross sectional side view of two pieces of exemplary self-adhering roof underlayment being attached together on a roof with the activator layer and adhesive extension activator layer of the second self-adhering roof underlayment configured to adhere to the adhesive layer of the first self-adhering roof underlayment.

FIG. 8 shows a perspective view of the self-adhering underlayment with both the adhesive release liners removed from the adhesive layers of the first and second self-adhering roof underlayment and the adhesive layer of a first self-adhering underlayment being attached to the activator layers of the second self-adhering underlayment bonding to the adhesive layer of the first self-adhering roof underlayment.

Corresponding reference characters indicate corresponding parts throughout the several views of the figures. The figures represent an illustration of some of the embodiments of the present invention and are not to be construed as limiting the scope of the invention in any manner. Some of the figures may not show all of the features and components of the invention for ease of illustration, but it is to be understood that where possible, features and components from one figure may be included in the other figures. Further, the figures are not necessarily to scale, some features may be exaggerated to show details of particular components. Therefore, specific structural and functional details disclosed herein are not to be interpreted as limiting, but merely as a representative basis for teaching one skilled in the art to variously employ the present invention.

### DETAILED DESCRIPTION OF THE ILLUSTRATED EMBODIMENTS

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Also, use of “a” or “an” are employed to describe elements and components described herein. This is done merely for convenience and to give a general sense of the scope of the invention. This description should be read to include one or at least one and the singular also includes the plural unless it is obvious that it is meant otherwise.

Certain exemplary embodiments of the present invention are described herein and are illustrated in the accompanying figures. The embodiments described are only for purposes of illustrating the present invention and should not be interpreted as limiting the scope of the invention. Other embodiments of the invention, and certain modifications, combinations, and improvements of the described embodiments, will occur to those skilled in the art and all such alternate embodiments, combinations, modifications, improvements are within the scope of the present invention.

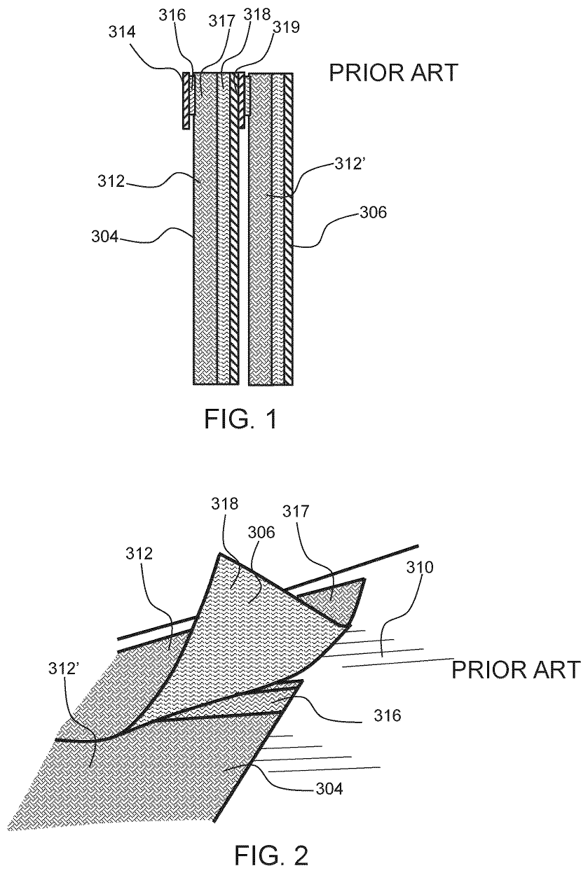

FIG. 1 shows a cross sectional view of layers of roof underlayment 312, 312′ of the prior art including a barrier layer 317 and an adhesive release liner 319 over the adhesive layer 318 and a second surface adhesive liner 314 over a surface adhesive strip 316 configured on the surface side 304 to bond to the adhesive layer 318 when configured on a roof.

FIG. 2 shows a perspective view of the prior art roof underlayment with both release liners removed and being attached to a roof 310 with the surface adhesive strip 316 bonding to the adhesive layer 318 on the roof side 306 of the roof underlayment.

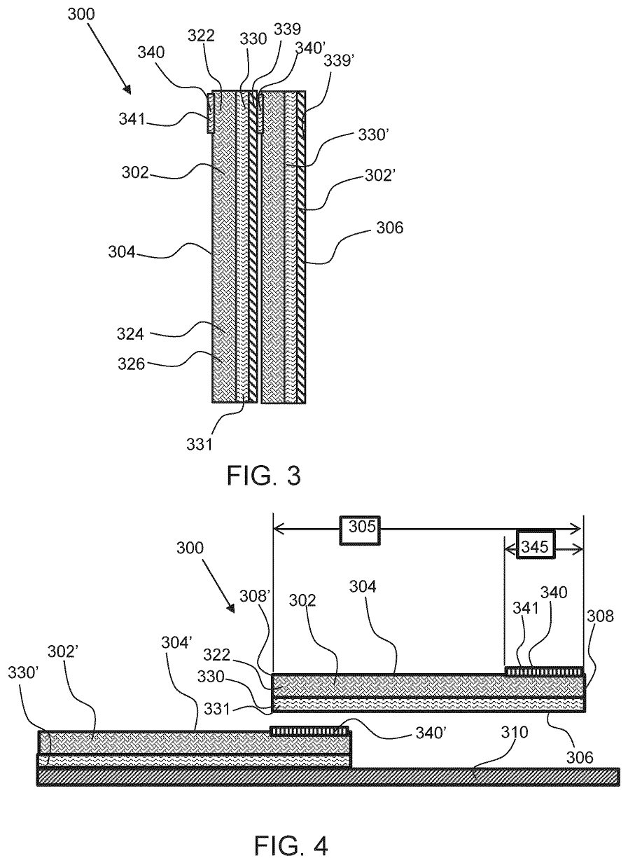

Referring now to FIGS. 3 to 5, an exemplary self-adhering roof underlayment system 300 includes layers of self-adhering roof underlayment 302, 302′ that each have a barrier layer 322, an adhesive layer 330 on the roof side 306 and an activator layer 340 on a surface side 304 to activate the adhesive 306 of an overlayed self-adhering roof underlayment 302. The barrier layer may include a structural component 324 for strength and a water barrier component 326 to prevent water passing through the self-adhering roof underlayment. An adhesive release liner 339 is configured over the adhesive layer when in a rolled configuration, as shown in FIG. 3. The activator layer 340 may have an activator chemical 341 that is configured to chemically react with an adhesive 331 of an adhesive layer 330, and may cross-link with the adhesive of the adhesive layer to form a strong bond.

As shown in FIG. 4, the two pieces of exemplary self-adhering roof underlayment 302, 302′ are being attached together on a roof 310 with the activator layer 340′ on the surface side 304′ of the second self-adhering roof underlayment 302′ contacting the adhesive 331 of the adhesive layer 306 on the roof side 306 of the first self-adhering roof underlayment 302. The activator layer will activate the adhesive 331 to bond to the activator layer 340′ to bond the two self-adhering roof underlayment 302, 302′ together. The adhesive layer 330′ of the second self-adhering roof underlayment 302′ is bonded to the roof 310 and a portion of the adhesive layer 330 will also be bonded to the roof 310 when the first self-adhering roof underlayment 302 is lowered onto the roof 310. The first self-adhering roof underlayment 302 also has an activator strip 340 that is configured to bond to the adhesive layer of a third self-adhering roof underlayment (not shown) when configured over the second self-adhering roof underlayment.

As shown in FIG. 4, the activator layer 340 has a width 345 that may be a proportion of the overall width 305 of the first self-adhering roof underlayment 302 from a first edge 308 to a second opposing edge 308′, such as about 20% or less, about 10% or less, or 5% or less. Put another way, the width 345 of the activator layer may be about 10 mm or more, about 20 mm or more, about 30 mm or more, about 50 mm or more, about 100 mm or less and any range between and including the values provided.

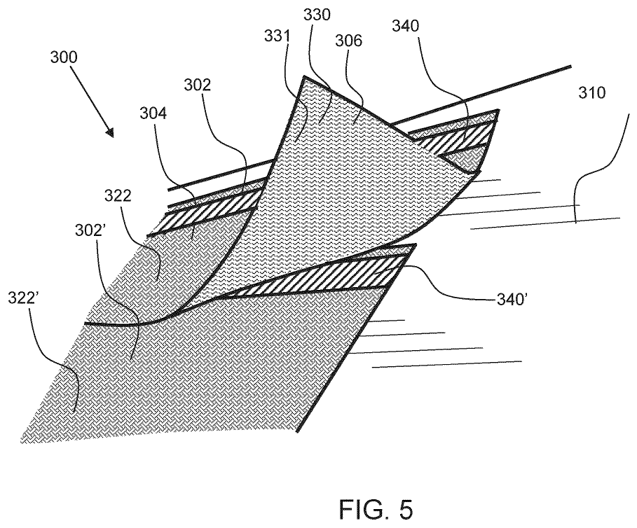

As shown in FIG. 5, the first self-adhering underlayment 302 is being overlapped on the second self-adhering roof underlayment 302′ such that the activator layer 340′ of the second self-adhering roof underlayment is contacting the adhesive 331 of the adhesive layer 330 of the first self-adhering roof underlayment. With reference to FIG. 3, both of the adhesive release liner 339, 339′ are removed from the respective adhesive layers 330, 330′ before application to a roof surface 310, as shown in FIGS. 4 and 5.

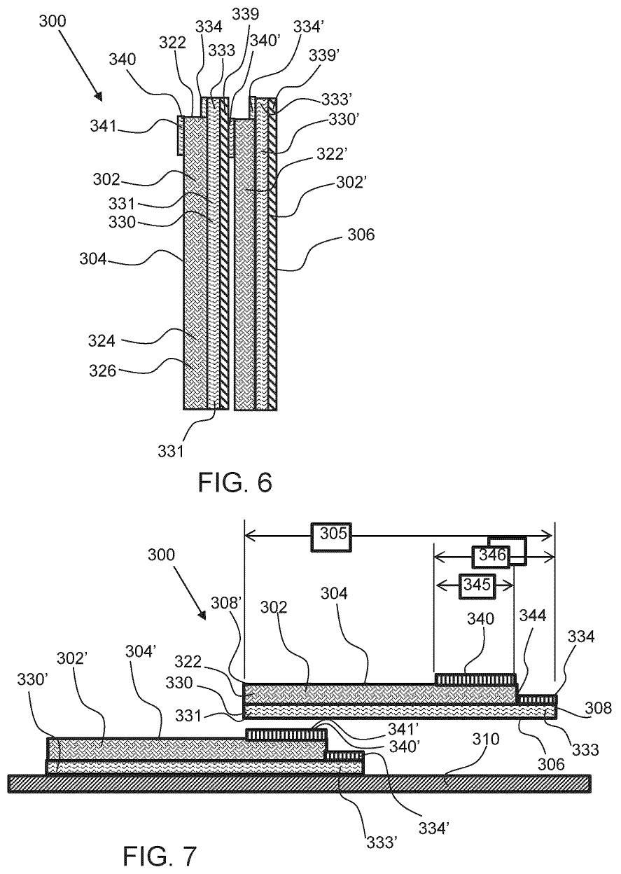

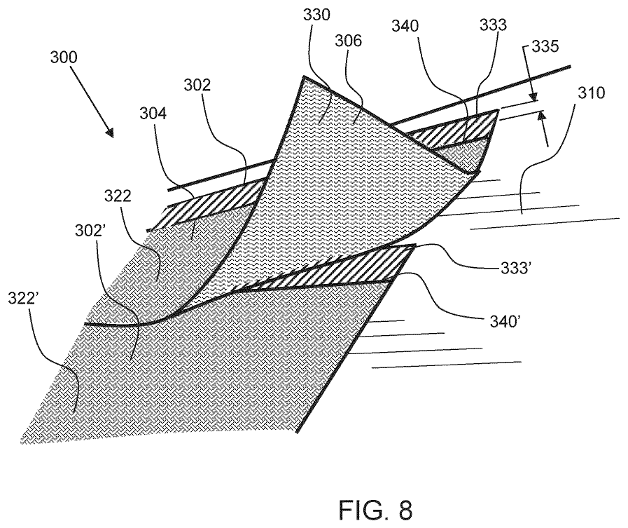

Referring now to FIG. 6 to FIGS. 8, the two pieces of exemplary self-adhering roof underlayment 302, 302′ are being attached together on a roof 310 with the activator layer 340′ on the surface side 304′ of the second self-adhering roof underlayment 302′ contacting the adhesive layer 330 on the roof side 306 of the first self-adhering roof underlayment 302. The activator chemical 341′ of the activator layer 340′ will activate the adhesive 331 of the adhesive layer 330 to bond to the activator layer. The adhesive layer 330′ of the second self-adhering roof underlayment 302′ is bonded to the roof 310. As shown in FIG. 6, the activator strip of the first self-adhering roof underlayment is configured to bond to the adhesive layer of a third self-adhering roof underlayment (not shown) when configured over the second self-adhering roof underlayment. The activator layers 340, 340′ do not require a release liner as there is a release liner over the respective adhesive layers 330, 330′ that is configured for removal before application to a roof surface 310, as shown in FIG. 8. The elimination of the surface release liner 314 as shown in FIG. 1 saves on material and time when applying the roof underlayment to a roof.

Also in this embodiment, the adhesive layers 330, 330′ extend beyond the edge of the respective barrier layers 322, 322′ to produce an adhesive extension 333, 333′ and an adhesive extension activator layer 334, 334′ is configured on this adhesive extension to prevent sticking and adhesion of the exposed adhesive extensions. This configuration enables the adhesive 331 of the adhesive layer 330 of the first self-adhering roof underlayment 302 to bond with the activator layer 340′ and the adhesive extension activator layer 334′ of the second self-adhering roof underlayment 302′. As shown in FIG. 8, the adhesive extension 333 and adhesive extension activator layer 334 have an extension distance 335 from the barrier layer 322 that may be about 10 mm or more, about 15 mm or more, about 20 mm or more, about 30 mm or more, about 40 mm or more, about 50 mm or more and any range between and including the values provided. This arrangement produces two separate adhesive bonds between the two pieces of self-adhering roof underlayment 302, 302′. A first adhesive bond is between the adhesive layer of the first self-adhering roof underlayment 302 and the activator layer 340′, wherein the activator chemical 341′ of the activator layer 340′ forms a bond, or bonds to the adhesive 331 of the adhesive layer 330 but does not bond to the adhesive release liner 339, shown in FIG. 6. A second adhesive bond is between the adhesive extension activator layer 334′ of the second self-adhering roof underlayment 302′ and the adhesive layer 330 of the first self-adhering roof underlayment 302. These two parallel and adjacent adhesive bonds in the overlap area 344, having an overlapping width 346, between the first and second pieces of self-adhering roof underlayment better ensures that damned water and wind-driven water, such as rain, does not penetrate through the overlap areas of the pieces of self-adhering roof underlayment 302, 302′. Note that the barrier layers 322, 322′ do not extend to the edge 308 of the pieces of self-adhering roof underlayment 302, 302′ and the adhesive layers 330, 330′ extend to the edge.

FIG. 6 shows a side view of the layers of self-adhering roof underlayment 302, 302′, such as configured in a roll. Each of the first and second self-adhering roof underlayment has a barrier layer 322, 322′, an adhesive layer 330, 330′, an adhesive extension 333, 333′, an adhesive release liner 339, 339′ and an activator layer 340, 340′ and adhesive extension activator layer 334, 334′ on the surface sides, opposite the roof sides. The adhesive layers have an adhesive 331 that bonds to the overlapping layer of self-adhering roof underlayment when the adhesive release liner 339 is removed and the two pieces of self-adhering roof underlayment are layered one atop another on a roof.

It will be apparent to those skilled in the art that various modifications, combinations and variations can be made in the present invention without departing from the scope of the invention. Specific embodiments, features and elements described herein may be modified, and/or combined in any suitable manner. Thus, it is intended that the present invention cover the modifications, combinations and variations of this invention provided they come within the scope of the appended claims and their equivalents.

What is claimed is:

1. A method of adhering a first self-adhering roof underlayment to a second self-adhering roof underlayment comprising:
a) providing a first self-adhering roof underlayment comprising:
i) a barrier layer;
ii) an adhesive layer comprising an adhesive on a roof side of the self-adhering roof underlayment;
iii) an activator layer comprising an activator chemical on a surface side of the self-adhering roof underlayment, opposite the roof side;
a release liner configured over the adhesive layer;
b) providing a second self-adhering roof underlayment comprising:
i) a barrier layer;
ii) an adhesive layer comprising an adhesive on a roof side of the self-adhering roof underlayment;
iii) an activator layer comprising an activator chemical on a surface side of the self-adhering roof underlayment, opposite the roof side; and
a release liner configured over the adhesive layer;
c) removing the adhesive release liner from the adhesive layer of the first self-adhering roof underlayment and the second self-adhering roof underlayment;
d) placing the adhesive layer of said first self-adhering roof underlayment onto a roof;
e) overlapping the second self-adhering roof underlayment onto the first self-adhering roof underlayment, wherein the activator layer of the first self-adhering roof underlayment contacts the adhesive layer of the second self-adhering roof underlayment; and
f) wherein said activator chemical of the activator layer of the first self-adhering roof underlayment bonds to said adhesive of the adhesive layer of the second self-adhering roof underlayment.

2. The method of claim 1, wherein the adhesive of the adhesive layer is a pressure sensitive adhesive.

3. The method of claim 1, wherein barrier layer comprises a structural component and a water barrier component.

4. The method of claim 3, wherein the structural component is a woven fabric.

5. The method of claim 4, wherein the water barrier component is a polymer coating on the barrier component.

6. The method of claim 4, wherein the water barrier component is a polymer film coupled to the barrier component.

7. The method of claim 6, wherein the polymer film is an olefin.

8. The method of claim 1, wherein the activator chemical of the activator layer of a first self-adhering roof underlayment chemically bonds with the adhesive of the adhesive layer of a second self-adhering roof underlayment.

9. The method of claim 8, wherein the activator chemical of the activator layer of a first self-adhering roof underlayment cross-links with the adhesive of the adhesive of the adhesive layer of a second self-adhering roof underlayment.

10. The method of claim 8, wherein the activator layer has a width of no more than 100 mm.

11. The method of claim 8, wherein the activator layer has a width of no more than 50 mm.

12. The method of claim 1, wherein the activator layer is configured in a strip along an edge of the self-adhering roof underlayment.

13. The method of claim 1, wherein both the first self-adhering roof underlayment and the second self-adhering roof underlayment comprise an adhesive extension that extends from an edge of the barrier layer of the self-adhering roof underlayment.

14. The method of claim 13, further comprising an adhesive extension activator layer configured over the adhesive extension.

15. The method of claim 14, wherein the adhesive extension extends from the barrier layer an extension distance of 10 mm or more.

16. The method of claim 15, wherein the adhesive extension activator layer of the first self-adhering roof underlayment bonds to the adhesive of the adhesive layer of the second self-adhering roof underlayment.

17. The method of claim 13, wherein the adhesive release liner extends over the adhesive extension.

18. The method of claim 13, wherein the adhesive release liner extends over the adhesive extension.

19. The method of claim 1, wherein the activator chemical of the activator layer of a first self-adhering roof underlayment chemically bonds with the adhesive of the adhesive layer of a second self-adhering roof underlayment,
wherein the activator layer is configured in a strip along an edge of the self-adhering roof underlayment, and
wherein the activator layer has a width of no more than 100 mm.

20. The method of claim 19, wherein barrier layer comprises a structural component and a water barrier component;
wherein the structural component is a woven fabric; and
wherein the water barrier component is a polymer film coupled to the barrier component.
